(19) United States
(12) Patent Application Publication
(10) Pub. No.: US 2022/0355748 A1
(43) Pub. Date: Nov. 10, 2022

(54) WIRING SYSTEM AND METHOD FOR MANUFACTURING CHANGED WIRING SYSTEM

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akira JINNO, Mie (JP); Hideaki ITO, Mie (JP)

(21) Appl. No.: 17/621,439

(22) PCT Filed: Jun. 11, 2020
(86) PCT No.: PCT/JP2020/022969

§ 371 Date: Dec. 21, 2021

(30) Foreign Application Priority Data
Jul. 2, 2019 (JP) 2019-123552

(51) Int. Cl. B60R 16/02; H02G 3/04; H02G 3/16

(52) U.S. Cl. CPC B60R 16/0215; H02G 3/0406; H02G 3/16

(57) ABSTRACT

An object is to facilitate arrangement of a plurality of wiring members in a vehicle, while enabling partial exchange and removal of the plurality of wiring members to be easily handled. Provided is a wiring system including a control unit, a plurality of devices that are connected to the control unit, a plurality of wiring members that forms at least a portion of a wiring path that connects the control unit and the plurality of devices, and a plurality of protection portions, wherein the plurality of protection portions protect the plurality of wiring members by grouping the wiring members into a plurality of groups, and the plurality of protection portions are linked in a separable manner.

### TECHNICAL FIELD

The present disclosure relates to a wiring system and a method for manufacturing a changed wiring system.

### BACKGROUND

Patent document 1 discloses that a wire and a signal line are branched in an intermediate branch box and connected to loads. Patent Document 1 also discloses that a control unit may be provided in the intermediate branch box, and that connectors provided at end portions of wire harnesses that are drawn from the loads are connected to connectors provided in the intermediate branch box.

### PRIOR ART DOCUMENT

### Patent Document

Patent Document 1: WO 2018/229918 A1

### SUMMARY OF THE INVENTION

### Problems to be Solved

Here, when the control unit is connected to a plurality of loads, it is desired that the task of wiring the wire harnesses is made easier. Further, the loads mounted in a vehicle may be exchanged or removed. In such a case, it is desired that partial exchange and removal of the wire harnesses can be readily handled.

In view of this, an object of the present disclosure is to facilitate arrangement of a plurality of wiring members in a vehicle while enabling partial exchange and removal of the plurality of wiring members to be readily handled.

### Means to Solve the Problem

A wiring system according to the present disclosure is a wiring system including a control unit, a plurality of devices that are connected to the control unit, a plurality of wiring members that form at least a portion of a wiring path that connects the control unit and the plurality of devices, and a plurality of protection portions, wherein the plurality of protection portions protect the plurality of wiring members by grouping the wiring members into a plurality of groups, and the plurality of protection portions are linked in a separable manner.

### Effect of the Invention

According to the present disclosure, a plurality of wiring members can be readily arranged in a vehicle, while enabling partial exchange and removal of the plurality of wiring members to be readily handled.

### BRIEF DESCRIPTION OF THE DRAWINGS

FIG. 1 is an illustrative diagram showing a state in which a wiring system is mounted in an automobile.

FIG. 2 is a perspective view showing a protection portion.

FIG. 3 is a plan view showing the protection portion.

FIG. 4 is a plan view showing an example in which the protection portion is branched at an intermediate portion.

FIG. 5 is a plan view showing another example in which the protection portions protect wiring members.

FIG. 6 is an illustrative diagram showing how a protection portion is removed.

FIG. 7 is an illustrative diagram showing how another protection portion is added.

### DETAILED DESCRIPTION TO EXECUTE THE INVENTION

Description of Embodiments of Disclosure First, embodiments of the present disclosure will be listed and described.

The wiring system according to the present disclosure is as follows.

(1) A wiring system including a control unit, a plurality of devices that are connected to the control unit, a plurality of wiring members that form at least a portion of a wiring path that connects the control unit and the plurality of devices, and a plurality of protection portions, wherein the plurality of protection portions protect the plurality of wiring members by grouping the wiring members into a plurality of groups, and the plurality of protection portions are linked in a separable manner. Since the plurality of protection portions are linked in a separable manner, the plurality of wiring members can be collectively and easily arranged in the vehicle. Also, since the plurality of protection portions can be separated, partial change and removal of the plurality of wiring members can be readily handled.

(2) A configuration is also possible in which the plurality of wiring members include a common wiring member that is wired in common in a vehicle, and a selective wiring member that is selectively wired in the vehicle, and the common wiring member and the selective wiring member are separately protected by the protection portions.

(3) A configuration is also possible in which the common wiring member includes at least one of a wiring member for an air bag and a wiring member for a brake. At least one of the wiring member for the air bag and the wiring member for the brake can be readily left mounted in the vehicle as the common wiring member.

(4) A configuration is also possible in which the selective wiring member includes at least one of a wiring member for a head lamp, a wiring member for an air conditioner, a wiring member for in-vehicle lighting, and a wiring member for a speaker. At least one of the wiring member for the head lamp, the wiring member for the air conditioner, the wiring member for in-vehicle lighting, and the wiring member for a speaker can be readily removed from the vehicle as the selective wiring member.

(5) A configuration is also possible in which a plurality of protection portions are linked via a link portion, and a break line which facilitates breaking is formed in the link portion. Due to the break line, the plurality of protection portions can be readily separated.

(6) A configuration is also possible in which each end portion of the plurality of wiring members is connected to a connector in a state in which the end portions are divided by at least the plurality of protection portions. The plurality of wiring members are disconnected from and connected to the devices that serve as connection destinations, via the connectors, for each protection portion.

The method for manufacturing a changed wiring system according to the present disclosure is as follows.

(7) A method for manufacturing a changed wiring system, including (a) a step of arranging a wiring system in a vehicle, the wiring system including a plurality of wiring members and a plurality of protection portions and in which the plurality of wiring members that are grouped into a plurality of groups are protected by the plurality of protection portions, and the plurality of protection portions are linked in a separable manner, and (b) a step of, after the step (a), separating a portion and a remaining portion of the plurality of protection portions, and removing, from the vehicle, the protection portion of the remaining portion and the wiring member that is protected by the remaining protection portion in a state in which the protection portion of the portion and the wiring member that is protected by the protection portion of the portion is left in the vehicle. Since the plurality of protection portions are linked in a separable manner, the plurality of wiring members can be collectively and readily arranged in the vehicle. Also, since the plurality of protection portions can be separated, partial exchange or removal of the plurality of the wiring members can be readily handled.

Such a wiring system and method for manufacturing a changed wiring system are significant in the following points.

Recent years has seen the implementation of automatic driving of automobiles. Once automatic driving is realized, a passenger, who has conventionally driven an automobile, will be able to do other things other than driving while in the vehicle. In this manner, it is presumed that consumers of automobiles will find their desires in “things to do in the vehicle” in addition to conventional “driving”.

The inventor of the present invention investigated changes in the wire harness architecture in the case where consumers find desire in “things to do in the vehicle”. As a result, the inventor recognized that a case will occur in which unknown equipment for dealing with “things to do in the vehicle” may appear after an automobile has been manufactured or the like, and a wire harness architecture that is capable of being easily mounted in an automobile even in such a case is required.

Incidentally, a conventional wire harness architecture is formed by a wire harness in which a plurality of system circuits are bundled together. Note that, the system circuits are intended to be circuits regarding an equipment specification. In conventional wire harness architecture, addition of a new system circuit could only be handled by replacing the entire wire harness. The reason being, in conventional wire harness architecture, the wires of the plurality of system circuits forming the wire harness are bundled together with tape or the like. Accordingly, in conventional wire harness architecture, if unknown equipment appears, the system circuit cannot be easily replaced.

When the inventor of the present application predicted the future of automobiles, the inventor foresaw that, due to the consumers finding desire in the “things to do in the vehicles”, unknown equipment that has not yet existed in the automobile market will appear. The wire harness architecture according to the present disclosure exhibits a marked effect in that the system circuit can be easily replaced even if unknown equipment appears.

### DESCRIPTION OF EMBODIMENTS OF DISCLOSURE

Specific examples of a wiring system and a method for manufacturing a changed wiring system according to the present disclosure will be described below with reference to the drawings. The present disclosure is not limited to the embodiments disclosed herein, but defined in the claims, and intended to include all modifications within the meaning and the scope equivalent thereof.

### Embodiment

Hereinafter, a wiring system and a method for manufacturing a changed wiring system according to the present disclosure will be described. In the present embodiment, a wiring system that is suitable for change will be first described, and then a method for changing the wiring system to manufacture a changed wiring system will be described.

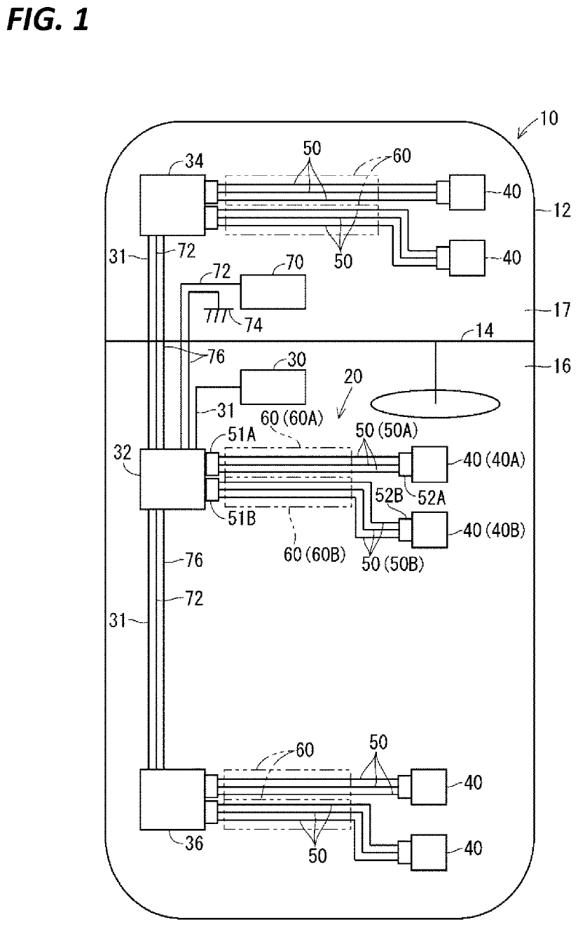

FIG. 1 is an illustrative diagram showing a state in which a wiring system 20 is mounted in an automobile 10. The automobile 10 is provided with a vehicle 12 including a body forming an outer shape of the automobile. The space inside the vehicle 12 is partitioned into a vehicle interior 16 and a front chamber 17 by a partitioning panel 14. The vehicle interior 16 is a space for accommodating passengers. The vehicle interior 16 may include a space for accommodating luggage. The front chamber 17 is a space located in front of the vehicle interior 16. If the automobile 10 is driven using internal combustion, the front chamber 17 is an engine room. If the automobile 10 is driven by an electrical motor, the front chamber 17 may also be a motor room. If the automobile 10 is driven using internal combustion and an electrical motor, the front chamber 17 may also be an engine-and-motor room. If the automobile 10 has an engine-and-motor room mounted in the rear of the vehicle, the front chamber 17 may conceivably be a luggage room.

One or more control units 30, 32, 34, and 36 are mounted in the automobile 10. The control units 30, 32, 34, and 36 are formed by a computer provided with a CPU (Central Processing Unit). Here, an example will be shown in which a central control unit 30 and area control units 32, 34, and 36 are mounted in the automobile 10. The central control unit 30 may also be referred to as a central ECU (Electronic Control Unit). The area control units 32, 34, and 36 may also be referred to as area ECUs or zone ECUs. In the case where the automobile 10 is considered as being spatially divided into a plurality of areas, the area control units 32, 34, and 36 are respectively arranged in the plurality of areas. Here, an example will be shown in which the automobile 10 is divided into an area inside the front chamber 17 and two areas, namely, front and rear areas, in the above vehicle interior 16. The way areas are divided described above is merely an example, and the automobile 10 may be divided into more or fewer areas. Further, a space in the automobile may be divided into right and left areas, or areas may be divided by a floor, a roof, and the like.

A plurality of devices 40 are respectively provided in the plurality of areas. For each area, the area control units 32, 34, and 36 are connected to the respective devices 40 arranged in their area via signal lines. In this manner, the area control units 32, 34, and 36 at least transmit or receive signals to/from the respective devices that belong to the areas.

The central control unit 30 is connected to the area control units 32, 34, and 36 via signal lines 31. In this manner, the central control unit 30 performs integrated control of the area control units 32, 34, and 36. Note that the central control unit 30 may also be omitted. Further, the area control units 32, 34, and 36 may also be omitted. In this case, a branch unit that branches the signal lines from the central control unit 30 may also be provided at portions where the area control units 32, 34, and 36 are provided.

In the present embodiment, a power source 70 is provided in the automobile 10. The power source 70 and the plurality of area control units 32, 34, and 36 are directly or indirectly connected to each other via power source lines 72. In this manner, power is supplied from the power source 70 to the area control units 32, 34, and 36. Also, a grounded portion 74 of the vehicle is directly or indirectly connected to a plurality of area control units 32, 34, and 36 via ground lines 76. The power source circuit and the ground circuit may also be configured as wiring of systems that are separate from the above signal circuit. Note that, the wire 70 and the grounded portion 74 may also be connected to the central control unit 30 via a power source line 72 and a ground line 76 and the like.

A plurality of connectors are provided to the area control units 32, 34, and 36.

An example of the wiring system 20 mounted in this automobile 10 will be described focusing on the area control unit 32. The wiring system 20 includes the area control unit 32 as an example of the control unit, a plurality of devices 40, a plurality of wiring members 50, and a plurality of protection portions 60. An example of the wiring system 20, which will be described below, can be similarly applied to the other area control units 34 and 36.

The plurality of devices 40 are connected to the area control unit 32. Here, a device 40A and a device 40B are shown as the plurality of devices 40. Hereinafter, when distinguishing between the plurality of devices 40, they are distinguished as “device 40A” and “device 40B”. A greater number of devices 40 may also be provided.

The plurality of wiring members 50 are portions forming at least part of the wiring paths that connect the area control unit 32 to the plurality of devices 40A and 40B. Here, the plurality of wiring members 50 include a wiring member 50A and a wiring member 50B. Hereinafter, when distinguishing between the plurality of wiring members 50, they are distinguished as “wiring member 50A” and “wiring member 50B”.

The wiring member 50A is a wiring member for connecting the area control unit 32 and the device 40A to each other. More specifically, the wiring member 50A is formed by wires. Here, the wiring member 50A includes a signal transmission wire, a power transmission wire, and a grounding wire. The number of signal wires may be one, or two or more. The wiring member 50A may also include optical fibers.

The wiring member 50B is a wiring member for connecting the area control unit 32 and the device 40B to each other. More specifically, the wiring member 50B is formed by wires. Here, the wiring member 50B includes a signal transmission wire, a power transmission wire, and a grounding wire. The number of signal wires may be one, or two or more. The wiring member 50B may also include optical fibers.

The protection portions 60 are members that can protect the wiring members 50. For example, the protection portions 60 are tubular members, and can protect the wiring members 50 with the wiring members 50 inserted thereto. A plurality of protection portions 60 protect the wiring members 50 for each of the plurality of groups.

Here, the protection portions 60A and 60B are shown as the plurality of protection portions 60. Hereinafter, when distinguishing between the plurality of protection portions 60, they are distinguished as “protection portion 60A” and “protection portion 60B”. A greater number of protection portions 60 may also be provided.

The protection portion 60A protects the above wiring member 50A, and the protection portion 60B protects the wiring member 50B. In other words, the protection portions 60A and 60B protect the plurality of wiring members 50A and 50B by grouping the wiring members 50A and 50B into a plurality of groups.

The plurality of protection portions 60A and 60B are linked in a separable manner. In other words, although the plurality of protection portions 60A and 60B can be handled as integral members, the protection portions 60A and 60B can be separately handled as necessary.

An example of such protection portions 60A and 60B will be described later.

End portions of the plurality of wiring members 50A and 50B are respectively connected to the connectors 51A, 52A, 51B, and 52B in a state in which they are separated by at least the plurality of protection portions 60A and 60B.

Here, one end portion of the wiring member 50A is connected to the connector 51A and the other end portion is connected to the connector 52A. The connectors 51A and 52A each include a signal terminal, a power source terminal, and a ground terminal, and are connected to the signal transmission wire, the power transmission wire, and the grounding wire of the wiring members 50A, respectively. The connector 51A is connected to one connector of the area control unit 32. The connector 52A is connected to the device 40A. In this manner, the area control unit 32 and the device 40A are communicably connected to each other so that power can be supplied.

Also, one end portion of the wiring member 50B is connected to the connector 51B, and the other end portion is connected to the connector 52B. The connectors 51B and 52B each include a signal terminal, a power source terminal, and a ground terminal, and are connected to a signal transmission wire, a power transmission wire, and a ground wire of the wiring member 50B, respectively. The connector 51B is connected to the other connector of the area control unit 32. The connector 52B is connected to the device 40B. In this manner, the area control unit 32 and the device 40B are communicably connected to each other so that power can be supplied.

The connector 51A and the connector 51B that are connected to the area control unit 32 are separated by the protection portion 60A and the protection portion 60B. Also, the connector 52A and the connector 52B that are connected to the devices 40A and 40B are separated by the protection portion 60A and the protection portion 60B. For this reason, the wiring members 50A and 50B that are protected separately by the protection portions 60A and 60B can be separately removed from the area control unit 32 and the device 40A or the device 40B.

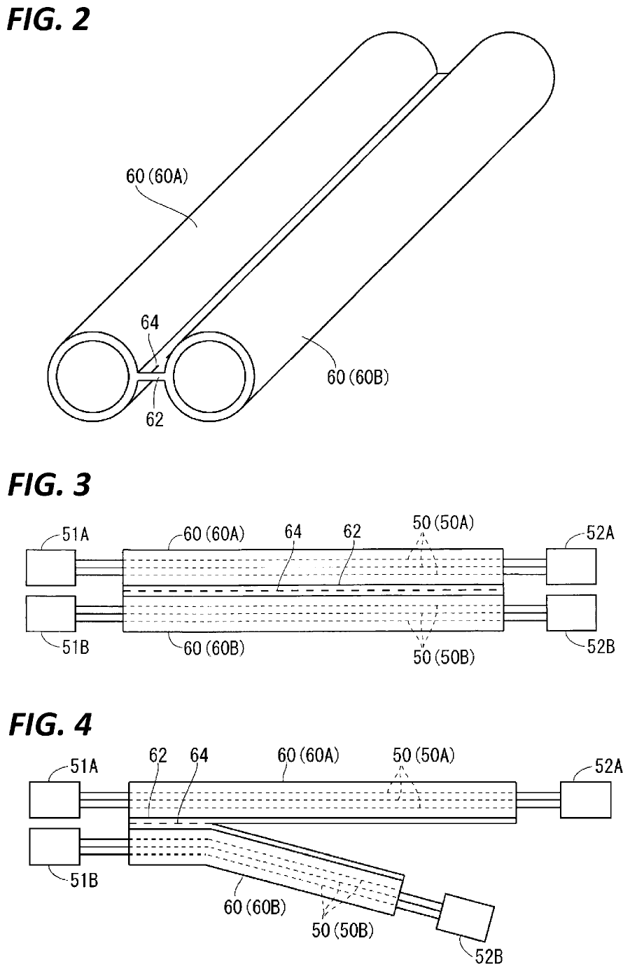

An example of the protection portions 60A and 60B will be described. FIG. 2 is a perspective view showing the protection portions 60A and 60B. FIG. 3 is a plan view showing the protection portions 60A and 60B. FIG. 2 shows a state in which the wiring members 50A and 50B are inserted into the protection portions 60A and 60B.

The protection portions 60A and 60B are linked by a link portion 62.

The protection portions 60A and 60B are each formed in a tubular shape. The protection portions 60A and 60B may be formed in a cylindrical, elliptical cylindrical, or angular cylindrical shape.

The link portion 62 is a portion that links the plurality of protection portions 60A and 60B. The link portion 62 links the two protection portions 60A and 60B in parallel. Three or more protection portions may also be provided. In this case, the link portion may be provided as a portion that links protection portions that are adjacent to each other, out of the plurality of protection portions arranged in parallel.

A break line 64 that facilitates breaking is formed in the link portion 62. The break line 64 is a linear portion that is easier to break than other portions. The break line 64 may also be a portion in which elongated slits or holes are intermittently formed. The break line 64 may also be a groove-like portion. The break line 64 extends along the axial direction of the protection portions 60A and 60B between the protection portions 60A and 60B. For this reason, when the link portion 62 is broken at the break line 64, the plurality of protection portions 60A and 60B are wholly or partially separated along the extending direction thereof.

A configuration in which the protection portions 60A and 60B are linked in an easily separable manner is not limited to the above example. For example, a configuration is also possible in which the protection portions 60A and 60B are bundled with a binding member such as string or tape, and the string or tape are cut or the like when separation is performed. In this case, if the binding member is partially provided in the extending direction of the protection portion 60A, the protection portions 60A and 60B can be easily separated by cutting the binding member or the like.

The above linked body of the protection portions 60A and 60B may also be formed by injection molding a resin or the like. Depending on the kind of resin, the protection portions 60A and 60B may be formed as flexibly bendable protection portions.

When the wiring members 50A and 50B are inserted into the protection portions 60A and 60B, the wiring members 50A and 50B are protected by the protection portions 60A and 60B.

The connectors 51A and 51B at end portions on one side of the wiring members 50A and 50B are connected to the common area control unit 32. For this reason, the connectors 51A and 51B can be arranged side by side and relatively close to each other. The portions on the connectors 51A and 51B side of the plurality of protection portions 60A and 60B may also be left linked together by the link portion 62.

The connectors 52A and 52B at end portions on the other side of the wiring members 50A and 50B are connected to the other devices 40A and 40B. If the devices 40A and 40B are relatively close to each other, portions on the connectors 52A and 52B side of the plurality of protection portions 60A and 60B may also be left linked by the link portion 62. If the devices 40A and 40B are relatively spaced apart from each other, as shown in FIG. 4, the link portion 62 may also be broken at the portions on the connectors 52A and 52B side of the plurality of protection portions 60A and 60B. In this case, the plurality of protection portions 60A and 60B are arranged in the automobile 10 so as to be branched at an intermediate position from the area control unit 32 toward the devices 40A and 40B and extend in different directions.

The lengths of the protection portions 60A and 60B may be the same or different. If the distance between the area control unit 32 and the device 40A is different from the distance between the area control unit 32 and the device 40B, the protection portions 60A and 60B may be cut or the like according to the distances, and the protection portion 60A and the protection portion 60B may have different lengths, as shown in FIG. 4.

The plurality of protection portions 60A and 60B described above may include common wiring members that are wired in common in the vehicle and selective wiring members that are selectively wired in the vehicle.

The common wiring members are wiring members that are wired in the vehicle regardless of differences in the grade of the automobile, the optional equipment (initial optional equipment or retrofittable optional equipment), and the like. Such common wiring members are collectively protected by the protection portion 60A. For example, the common wiring members may also be at least one of an air bag wiring member and a brake wiring member that are generally provided regardless of the difference in the grade of the automobile and the like.

Note that the air bag wiring member that is equipped as optional equipment, such as a curtain air bag, may also be a selective wiring member. Also, the brake itself varies in accordance with the difference of the grade, and the brake wiring member may differ according to the grade. In such a case, the brake wiring member may also be a selective wiring member.

The selective wiring members are wiring members that are wired or not wired in the vehicle according to the difference in the grade of the automobile, the difference in the optional equipment, or the like. Such selective wiring members are grouped together separately from the common wiring members, and protected by the protection portion 60B.

The selective wiring members conceivably include at least one of a head lamp wiring member, an air-conditioner wiring member, an in-vehicle lighting wiring member, and a speaker wiring member, for example. Examples of the head lamp include a halogen lamp, a HID (High-Intensity Discharge lamp) lamp, an LED (Light Emitting Diode) lamp, and the like, and it is conceivable that the wiring member varies according to the selected type. Also, regarding an air conditioner, there are differences in manual air conditioning or automatic air conditioning, cooling performance, and the like, and it is conceivable that the wiring member varies according to what is selected. Regarding the in-vehicle lighting, there are also differences in the lighting position and the like, and it is conceivable that the wiring member varies according to what is selected. Also, regarding the speaker, there are differences in the installation position, installation number, and the like, and it is conceivable that the wiring member varies according to what is selected.

The wiring members may be protected by the protection portions by being grouped into the wiring members that are to be connected to devices that are generally considered related to driving or safety, such as airbags and a brake, and devices that are generally considered related to a body system, such as a head lamp, an air conditioner, an in-vehicle light, and speakers.

In the examples shown in FIGS. 3 and 4, the wiring member 50A is a common wiring member and the wiring member 50B is a selective wiring member, for example.

The above example described that the wiring member 50A for one device 40A is protected by the protection portion 60A, and the wiring member for one device 40B is protected by the protection portion 60B.

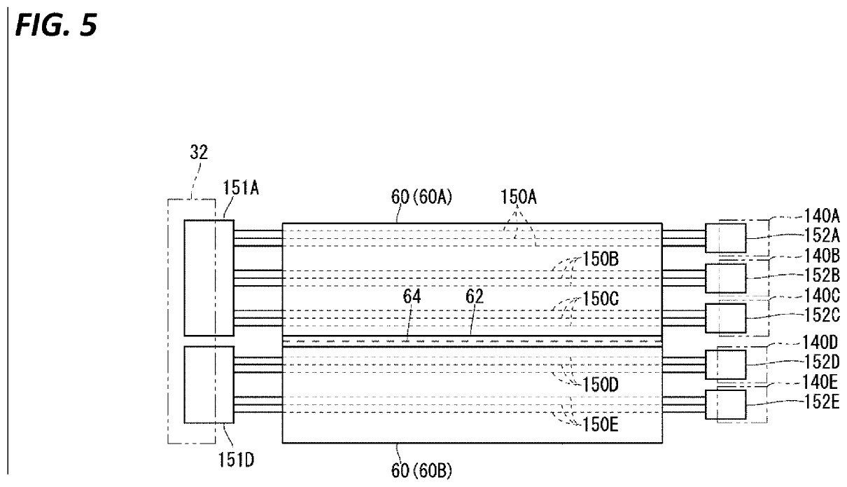

As shown in FIG. 5, the protection portions 60A and 60B may also protect wiring members for a plurality of devices. In the example shown in FIG. 5, the protection portion 60A protects wiring members 150A, 150B, and 150C respectively corresponding to a plurality of devices 140A, 140B, and 140C. End portions on one side of the wiring members 150A, 150B, and 150C are connected to a common connector 151A, and connected to an area control unit 32 via the connector 151A. The other end portions of the wiring members 150A, 150B, and 150C are connected to separate connectors 152A, 152B, and 152C, and separately connected to the devices 140A, 140B, and 140C, respectively.

Further, the protection portion 60B protects wiring members 150D and 150E for a plurality of devices 140D and 140E, respectively. End portions on one side of the wiring members 150D and 150E are connected to a common connector 151D, and connected to the area control unit 32 via the connector 151D. End portions on the other side of the wiring members 150D and 150E are connected to separate connectors 152D and 152E, and separately connected to the devices 140D and 140E, respectively.

In this example, end portions on one side of the plurality of wiring members 150A, 150B, 150C, 150D, and 150E are connected to the connector 151A and 152B in a state where they are divided by at least the plurality of protection portions 60A and 60B. Also, end portions on the other side of the plurality of wiring members 150A, 150B, 150C, 150D, and 150E are connected to the connectors 152A, 152B, 152C, 152D, and 152E in a state where they are divided by at least athe plurality of protection portions 60A and 60B, in other words, in a state where they are divided into the other end portions of the wiring members 150A, 150B, and 150C, and the other end portions of the wiring members 150D and 150E.

For this reason, for example, in the case where the wiring members 150A, 150B, and 150C are the common wiring members, the plurality of wiring members 150A, 150B, and 150C are collectively protected by the protection portion 60A. Also, in the case where the wiring members 150D and 150E are the selective wiring members, the plurality of wiring members 150D and 150E are collectively protected by the protection portion 60B separately from the wiring members 150A, 150B, and 150C.

An example in which changed wiring systems 220 and 320 are manufactured using the above wiring system 20 will be described below.

First, the above wiring system 20 is prepared. In the wiring system 20, the protection portions 60A and 60B are linked via the link portion 62. Also, the wiring members 50A and 50B are separately protected by the respective protection portions 60A and 60B. The wiring member 50A serving as the common wiring member is protected by the protection portion 60A, and the wiring member 50B serving as the selective wiring member is protected by the protection portion 60B.

This wiring system 20 is arranged in the vehicle 12 (step (a)). At this time, the connectors 51A and 51B are connected to the area control unit 32, and the connector 52A and 52B are connected to the devices 40A and 40B. The wiring members 50A and 50B themselves are also fixed to the vehicle 12 using a clamp or the like for fixing the wires as necessary. In this case, only the wiring member 50A may be fixed to the vehicle 12, and the wiring member 50B need not necessarily be fixed to the vehicle 12. The protection portions 60A and 60B may also be fixed to the vehicle 12 using a clamp for fixing wires or the like as necessary. In this case, only the protection portion 60A may be fixed to the vehicle 12 and the protection portion 60B need not necessarily be fixed to the vehicle. For example, if a clamp that includes a cable tie is used, the cable tie may penetrate the link portion 62 and be wound around only the protection portion 60A.

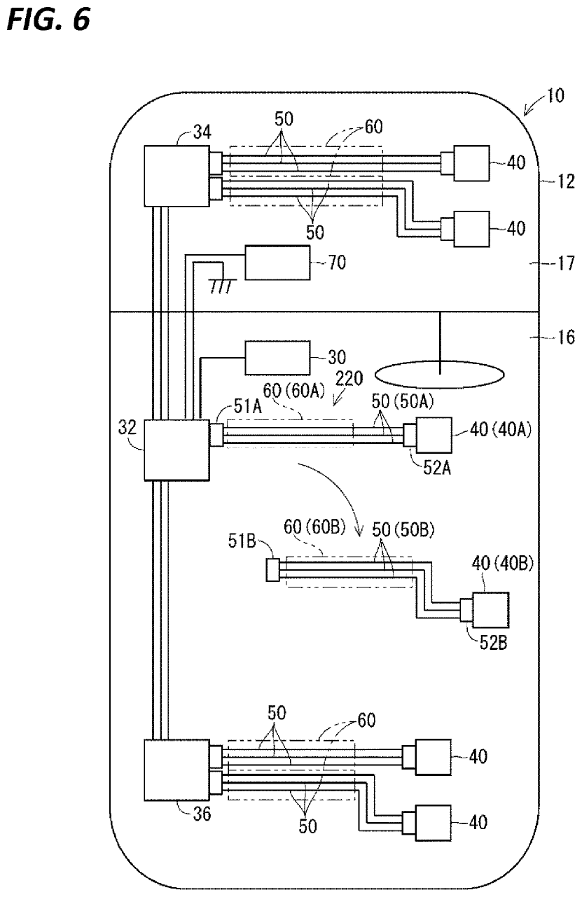

After performing the step (a), the wiring member 50B may need to be removed or changed to another wiring member, or the like. For example, there are cases in which the device to which the wiring member 50B is to be connected is removed, the device to which the wiring member 50B is to be connected is changed to another device, or the like. In this case, as shown in FIG. 6, the protection portions 60A and 60B are separated from each other. If three or more protection portions are provided, a portion thereof and the remaining portion may be separated. In the state where the protection portion 60A and the wiring member 50A protected by the protection portion 60A are left in the vehicle 12, the protection portion 60B and the wiring member 50B protected by the protection portion 60B are removed from the vehicle (step (b)). Note that the connectors 51B and 52B are removed from the area control unit 32 and the device 40B.

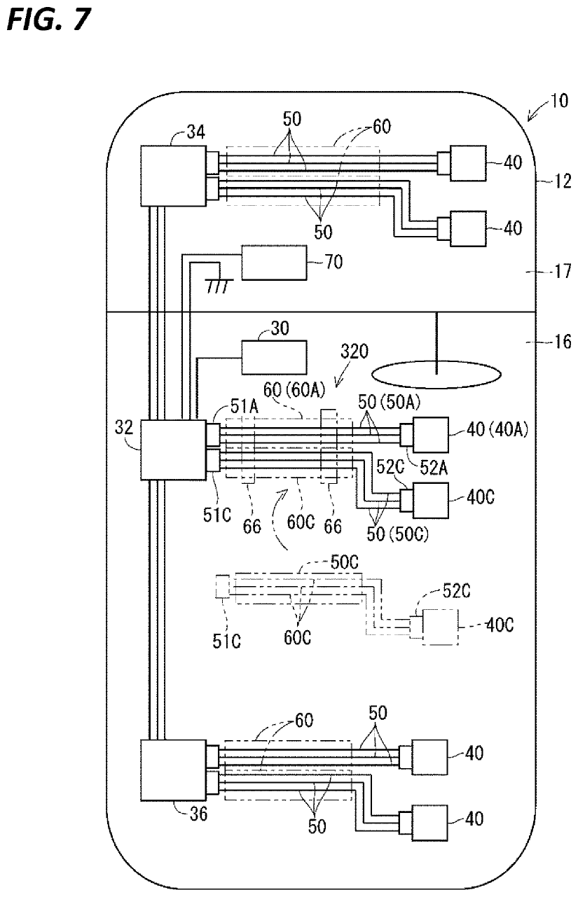

After that, as shown in FIG. 7, another wiring member 50C is arranged along the wiring member 50A as necessary. The wiring member 50C may also be protected by another protection portion 60A. One end portion of the wiring member 50C is connected to a connector 51C, and is connected to the area control unit 32 via the connector 51C. The other end portion of the wiring member 50C is connected to a connector 52C, and is connected to a new device 40C via the connector 52C. The wiring member 50C or the protection portion 60C may also be combined with the protection portion 60A. For example, a binding member 66 such as adhesive tape or a cable tie may be wound around the protection portions 60A and 60C to combine them. The binding member 66 may also be attached to partial portions in the longitudinal direction of the protection portions 60A and 60B.

When assuming an example shown in FIG. 5, a case is also possible in which the wiring members protected by the protection portion 60B and the wiring members protected by the protection portion 60C are partially different and the remaining portion is common. For example, the wiring members obtained by adding another wiring member to the plurality of the wiring members protected by the protection portion 60B may be the wiring members protected by the protection portion 60C. Also, for example, the wiring members obtained by removing a portion of the plurality of wiring members protected by the protection portion 60B or replacing the portion with the other wiring member may be the wiring members protected by the protection portion 60C.

In this manner, the wiring member 50A serving as the selective wiring member can be easily changed to the other wiring member 50C while the wiring member 50A serving as the common wiring member is left in the original state.

In this manner, the changed wiring system 220, which is formed by changing the wiring system 20 by removing the protection portion 60B and the wiring member 50B, can be easily manufactured. Alternatively, the changed wiring system 320, which is formed by changing the wiring system 20 by arranging the protection portion 60C and the wiring member 50C instead of the protection portion 60B and the wiring member 50B can be easily manufactured.

According to the wiring system 20 and the manufacturing method for the changed wiring systems 220 and 320 configured as above, since the plurality of protection portions 60A and 60B are linked in a separable manner via the link portion 62, the plurality of wiring members 50A and 50B can be collectively arranged in the vehicle 12 with ease. Also, since the plurality of protection portions 60A and 60B are separated, partial exchange or removal of the plurality of wiring members 50A and 50B can be readily handled.

Further, the plurality of wiring members 50A and 50B include the common wiring member (wiring member 50A) and the selective wiring member (wiring member 50B), and these are protected by separate protection portions 60A and 60B. For this reason, while the common wiring member (wiring member 50A) is mounted in the vehicle 12, the selective wire member (wire member 50A) can be easily removed and the selective wiring member (wiring member 50A) can be easily replaced with the other wiring member 50C as necessary.

Further, the plurality of protection portions 60A and 60B can be easily divided along the break line 64.

Further, the end portions of the plurality of wiring members 50A and 50B are connected to the connectors 51A, 52A, 51B, and 52B in the state in which the wiring members 50A and 50B are divided by at least the protection portions 60A and 60B. For this reason, the protection portions 60A and 60B can separately be connected to and disconnected from the area control unit 32, the devices 40A and 40B, which are connection destinations.

Note that the configurations described in the above embodiment and variations can be combined with each other as appropriate as long as no contradiction arises.

List of Reference Numerals

| | |
|---|---|
| 10 | Automobile |
| 12 | Vehicle |
| 14 | Partitioning panel |
| 16 | Vehicle interior |
| 17 | Front chamber |
| 20 | Wiring system |
| 30 | Central control unit |
| 31 | Signal line |
| 32, 34, 36 | Area control unit |
| 40 (40A, 40B, 40C) | Device |
| 50(50A, 50B, 50C) | Wiring member |
| 51A, 51B, 51C, 52A, 52B, 52C | Connector |
| 60 (60A, 60B, 60C) | Protection portion |
| 62 | Link portion |
| 64 | Break line |
| 66 | Binding member |
| 70 | Power source |
| 72 | Power source line |
| 74 | Grounded portion |
| 76 | Ground line |
| 140A, 140B, 140C, 140D, 140E | Device |
| 150A, 150B, 150C, 150D, 150E | Wiring member |
| 151A, 151D, 152A, 152B, 152C, | Connector |
| 152D, 152E | |
| 220, 320 | Wiring system |

1. A wiring system comprising:
a control unit;
a plurality of devices that are connected to the control unit;
a plurality of wiring members that form at least a portion of a wiring path that connects the control unit and the plurality of devices; and
a plurality of protection portions,
wherein the plurality of protection portions protect the plurality of wiring members by grouping the wiring members into a plurality of groups,
the plurality of protection portions are linked in a separable manner via a link portion, and
a break line which facilitates breaking is formed in the link portion.

2. The wiring system according to claim 1,
wherein the plurality of wiring members include a common wiring member that is wired in common in a vehicle, and a selective wiring member that is selectively wired in the vehicle, and
the common wiring member and the selective wiring member are separately protected by the protection portions.

3. The wiring system according to claim 2,
wherein the common wiring member includes at least one of a wiring member for an air bag and a wiring member for a brake.

4. The wiring system according to claim 2,
wherein the selective wiring member includes at least one of a wiring member for a head lamp, a wiring member for an air conditioner, a wiring member for in-vehicle lighting, and a wiring member for a speaker.

5. (canceled)

6. The wiring system according to claim 1,
wherein each end portion of the plurality of wiring members is connected to a connector in a state in which the end portions are divided by at least the plurality of protection portions.

7. A method for manufacturing a changed wiring system, comprising:
(a) a step of arranging a wiring system in a vehicle, the wiring system including a plurality of wiring members and a plurality of protection portions and in which the plurality of wiring members that are grouped into a plurality of groups are protected by the plurality of protection portions, and the plurality of protection portions are linked in a separable manner via a link portion in which a break line that facilitates breaking is formed, and
(b) a step of, after the step (a), separating a portion and a remaining portion of the plurality of protection portions, and removing, from the vehicle, the protection portion of the remaining portion and the wiring member that is protected by the remaining protection portion in a state in which the protection portion of the portion and the wiring member that is protected by the protection portion of the portion is left in the vehicle.

8. The method for manufacturing a changed wiring system according to claim 7,
wherein the plurality of wiring members form at least a portion of wiring paths that connect a control unit and a plurality of devices, and
the method further comprises
a step of bringing the wiring system to a state in which the plurality of protection portions are separated by breaking the link portion on the plurality of devices side while the plurality of protection portions are left linked together via the link portion on the control unit side.

9. The wiring system according to claim 1,
wherein the plurality of protection portions are linked together in a separable manner via the link portion on the control unit side, and the plurality of protection portions are separated and not linked on the plurality of devices side.
